(19) United States
(12) Patent Application Publication
(10) Pub. No.: US 2026/0228450 A1
(43) Pub. Date: Aug. 6, 2026

(54) METHODS AND SYSTEMS FOR PROVIDING EXAMPLES TO A LARGE LANGUAGE MODEL

(71) Applicant: Shopify Inc., Ottawa (CA)

(72) Inventors: Ben Lafferty, New York, NY (US); Alberto Castelo Becerra, A Coruna (ES); Michael Garner, La Crosse, WI (US); Charles Lee, South San Francisco, CA (US); Hong Wu, Los Altos, CA (US); Andrew McNamara, Belwood (CA); Felipe Bezerra Leusin de Amorim, Oakville (CA)

(21) Appl. No.: 19/074,989

(22) Filed: Mar. 10, 2025

Related U.S. Application Data
(60) Provisional application No. 63/754,085, filed on Feb. 5, 2025.

(51) Int. Cl. G06F 40/40

(52) U.S. Cl. CPC G06F 40/40

(57) ABSTRACT

Methods and systems providing examples to a large language model (LLM) are described. A conversation history is maintained for an ongoing conversation between a client and the LLM. A current client message is received from the client. An input is provided to the LLM to instruct the LLM to generate an output in response to the current client message, the input to the LLM including at least a portion of the conversation history and including one or more example message pairs inserted into the portion of the conversation history in proximity to the current client message, wherein each example message pair includes a respective example client message and a respective example LLM message. An LLM message is outputted to the client based on the output generated by the LLM in response to the input. The one or more example message pairs are omitted from the maintained conversation history.

### CROSS-REFERENCE TO RELATED APPLICATION

The present disclosure claims priority from U.S. provisional patent application No. 63/754,085, filed Feb. 5, 2025, entitled “METHODS AND SYSTEMS FOR PROVIDING EXAMPLES TO A LARGE LANGUAGE MODEL”, which is hereby incorporated by reference in its entirety.

### FIELD

The present disclosure relates to machine learning and large language models (LLMs), and, more particularly, to operation of an LLM in the context an ongoing conversation.

### BACKGROUND

A large language model (LLM) is a deep learning algorithm that can process natural language to summarize, translate, predict and generate text and other content. A LLM may be trained to learn billions of parameters in order to model how words relate to each other in a textual sequence. Inputs to a LLM may be referred to as prompts. A prompt is a natural language input that includes instructions to cause the LLM to generate a desired output. A client may interact with an LLM by providing messages to and receiving messages from the LLM in a conversation.

### SUMMARY

When a client (which may refer to a client system that a human user may be using, or may refer to a client system without a human user) is conducting an ongoing conversation (sometimes referred to as a chat or a chat session) with an LLM, a conversation history may be maintained that contains the messages in the ongoing conversation. When a client message is provided to the conversation, the current client message (i.e., the newly provided client message to which the LLM has not yet provided a message in response) may be used to generate an input (sometimes referred to as a prompt) to the LLM to cause the LLM to generate an appropriate LLM message in response. Sometimes the input to the LLM includes information in addition to the current client message, such as including at least a portion of the conversation history (which may help to provide contextual information to the LLM). In some examples, retrieval augmented generation (RAG) may be used to provide additional information (e.g., information retrieved from a datastore) in the input to the LLM.

Conventional RAG systems may use an N-shot prompting (also referred to as few-shot learning) strategy. N-shot prompting may be used to enable an LLM to generate an output (e.g., a message in a conversation) that is informed by information retrieved from a datastore. For example, if a client is engaged in conversation with an LLM, the RAG system may process a current client message, retrieve relevant information (e.g., one or more relevant text passages) from a datastore, and place the retrieved information in the system message portion of an input that is sent to the LLM. The LLM may then generate an output that is used to provide an LLM message in the conversation, where the output is based on the retrieved information. For example, the LLM may generate output that quotes from the retrieved text, that summarizes the retrieved text, etc. In some cases, N-shot prompting may be used to provide the LLM with examples of appropriate responses to the client message.

A challenge with conventional N-shot prompting is that providing examples in the input to the LLM, where the examples are provided in a singular message type or message role (e.g., in the system message, or where examples are prepended to a client message) may not help the LLM to generate output in the context of an ongoing conversation. This is because examples provided in a singular message (such as in the system message) may be processed by the LLM in a manner differently from client messages in a conversation. For example, an LLM may be trained on conversation-like messages, and may place greater attention on conversation-like text (which typically involve two or more parties in an exchange of two or more messages), particularly messages that are more recent in a conversation (typically messages closer to the end of the input). System messages are often less conversational in structure, and are often placed at the start of the input to an LLM. This means that as the input increases in length (e.g., if a long conversation history is included in the input), the LLM tends to place less attention on examples provided in the system message, thus the output generated by the LLM is less likely to be informed by those examples. As well, examples prepended to a client message may lack conversational structure, thus being less useful to the LLM that is trained on conversation-like messages, and may also obscure the intent of the client message.

In various examples, the present disclosure provides a technical solution for providing examples to the LLM that enables the LLM to generate output that is better informed by the examples. In examples described herein, an input to the LLM has one or more examples that resemble client/LLM message pairs (i.e., each example in the input has a client message and a corresponding LLM message, thus each example is a pair of messages) in a conversation (e.g., question and answer message pairs, request and response message pairs, etc.). The example(s) are retrieved from a datastore and dynamically inserted into the input to the LLM as example messages in a conversation history immediately preceding the current client message. Thus, the LLM is provided with examples that enable the LLM to mimic the conversational messages, in accordance with the content of the example LLM message in the client/LLM example message pairs. The result is that the output generated by the LLM is able to draw on information from retrieved data while at the same time being suitable for the context of an ongoing conversation

The present disclosure enables examples to be included in an input to an LLM in which the inserted examples mimic client/LLM messages in the conversation and are provided closer to (but not part of) the current client message. This provides a technical advantage in that the LLM is enabled to generate output with greater attention placed on the inserted examples, without the inserted examples obfuscating the current client message itself.

As described herein, the inserted examples may be removed from the conversation history after the LLM has generated an output so that the size of the conversation history is not increased by the inserted examples, saving resources (e.g., tokens, network bandwidth, memory, etc.) in subsequent input, that includes the conversation history, to the LLM. It should be noted that it may be much harder to remove examples provided in the system message (as in conventional N-shot prompting) and doing so may confuse the LLM. The present disclosure thus provides a more efficient and effective technique for providing examples to the LLM.

In an example aspect, the present disclosure describes a computer-implemented method including: maintaining a conversation history for an ongoing conversation between a client and a large language model (LLM), the conversation history containing one or more previous messages from the client and one or more previous messages from the LLM; receiving, from the client, a current client message for the ongoing conversation; providing an input to the LLM to instruct the LLM to generate an output in response to the current client message, the input to the LLM including at least a portion of the conversation history and including one or more example message pairs inserted into the at least the portion of the conversation history in proximity to the current client message, wherein each example message pair includes a respective example client message and a respective example LLM message; and outputting, to the client, an LLM message based on the output generated by the LLM in response to the input; wherein the one or more example message pairs are omitted from the maintained conversation history.

In an example of the preceding example aspect, for each example message pair, the respective example client message may be semantically similar to the current client message and the corresponding respective example LLM message may be a suitable response to the example client message.

In an example of the preceding example aspect, two or more example message pairs may be inserted into the at least the portion of the conversation history, wherein a first message pair having a first example client message that is more similar to the current client message may be inserted into the at least the portion of the conversation history in greater proximity to the current client message than a second message pair having a second example client message that is less similar to the current client message.

In an example of any of the preceding example aspects, the method may include: retrieving, from a datastore, the one or more example message pairs based on similarity to the current client message.

In an example of the preceding example aspect, the method may include: encoding the current client message into a query embedding to query the datastore; and retrieving the one or more example message pairs based on similarity between the query embedding and one or more example embeddings corresponding to the one or more example message pairs.

In an example of any of the preceding example aspects, the insertion of the one or more example message pairs into the at least the portion of the conversation history may be hidden from the client.

In an example of any of the preceding example aspects, the method may include: adding the current client message and the outputted LLM message to the maintained conversation history; and maintaining the conversation history free of the inserted one or more example message pairs.

In an example of any of the preceding example aspects, the method may include: receiving, from the client, a further client message for the ongoing conversation; providing a further input to the LLM to instruct the LLM to generate a further output in response to the further client message, the further input including at least a portion of the conversation history free of any previously inserted example message pairs, and including one or more new example message pairs inserted into the at least the portion of the conversation history in proximity to the further client message; and outputting, to the client, a further LLM message based on the further output generated by the LLM in response to the further input; wherein the one or more new example message pairs are omitted from the maintained conversation history.

In another example aspect, the present disclosure describes a computer system including at least one processor; and a computer readable medium storing instructions that, when executed by the at least one processor, cause the computer system to: maintain a conversation history for an ongoing conversation between a client and a large language model (LLM), the conversation history containing one or more previous messages from the client and one or more previous messages from the LLM; receive, from the client, a current client message for the ongoing conversation; provide an input to the LLM to instruct the LLM to generate an output in response to the current client message, the input to the LLM including at least a portion of the conversation history and including one or more example message pairs inserted into the at least the portion of the conversation history in proximity to the current client message, wherein each example message pair includes a respective example client message and a respective example LLM message; and output, to the client, an LLM message based on the output generated by the LLM in response to the input; wherein the one or more example message pairs are omitted from the maintained conversation history.

In an example of the preceding example aspect, for each example message pair, the respective example client message may be semantically similar to the current client message and the corresponding respective example LLM message may be a suitable response to the example client message.

In an example of the preceding example aspect, two or more example message pairs may be inserted into the at least the portion of the conversation history, wherein a first message pair having a first example client message that is more similar to the current client message may be inserted into the at least the portion of the conversation history in greater proximity to the current client message than a second message pair having a second example client message that is less similar to the current client message.

In an example of any of the preceding example aspects, the instructions may further cause the computer system to: retrieve, from a datastore, the one or more example message pairs based on similarity to the current client message.

In an example of the preceding example aspect, the instructions may further cause the computer system to: encode the current client message into a query embedding to query the datastore; and retrieve the one or more example message pairs based on similarity between the query embedding and one or more example embeddings corresponding to the one or more example message pairs.

In an example of any of the preceding example aspects, the insertion of the one or more example message pairs into the at least the portion of the conversation history may be hidden from the client.

In an example of any of the preceding example aspects, the instructions may further cause the computer system to: add the current client message and the outputted LLM message to the maintained conversation history; and maintain the conversation history free of the inserted one or more example message pairs.

In an example of any of the preceding example aspects, the instructions may further cause the computer system to: receive, from the client, a further client message for the ongoing conversation; provide a further input to the LLM to instruct the LLM to generate a further output in response to the further client message, the further input including at least a portion of the conversation history free of any previously inserted example message pairs, and including one or more new example message pairs inserted into the at least the portion of the conversation history in proximity to the further client message; and output, to the client, a further LLM message based on the further output generated by the LLM in response to the further input; wherein the one or more new example message pairs are omitted from the maintained conversation history.

In another example aspect, the present disclosure describes a non-transitory computer-readable medium storing instructions that, when executed by at least one processor of a computer system, cause the computer system to: maintain a conversation history for an ongoing conversation between a client and a large language model (LLM), the conversation history containing one or more previous messages from the client and one or more previous messages from the LLM; receive, from the client, a current client message for the ongoing conversation; provide an input to the LLM to instruct the LLM to generate an output in response to the current client message, the input to the LLM including at least a portion of the conversation history and including one or more example message pairs inserted into the at least the portion of the conversation history in proximity to the current client message, wherein each example message pair includes a respective example client message and a respective example LLM message; and output, to the client, an LLM message based on the output generated by the LLM in response to the input; wherein the one or more example message pairs are omitted from the maintained conversation history.

In an example of the preceding example aspect, for each example message pair, the respective example client message may be semantically similar to the current client message and the corresponding respective example LLM message may be a suitable response to the example client message.

In an example of the preceding example aspect, two or more example message pairs may be inserted into the at least the portion of the conversation history, wherein a first message pair having a first example client message that is more similar to the current client message may be inserted into the at least the portion of the conversation history in greater proximity to the current client message than a second message pair having a second example client message that is less similar to the current client message.

In an example of any of the preceding example aspects, the instructions may be further cause the computer system to: add the current client message and the outputted LLM message to the maintained conversation history; and maintain the conversation history free of the inserted one or more example message pairs.

In some examples, the computer-readable medium may store instructions that, when executed by the processor of the computing system, cause the computing system to perform any of the example aspect of the methods described above.

In another example aspect, the present disclosure provides a computer program including processor-executable instructions that, when executed by a processor of a computing system, cause the computing system to perform any of the example aspect of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram of an example conversation engine, in accordance with examples of the present disclosure;

FIG. 4 is a flowchart illustrating an example method for providing examples to a LLM, in accordance with examples of the present disclosure; and

FIGS. 5A and 5B illustrate a simplified example user interface showing operation of an example conversation engine, in accordance with examples of the present disclosure.

Similar reference numerals may have been used in different figures to denote similar components.

### DETAILED DESCRIPTION

In various examples, the present disclosure describes methods and systems for providing examples to an LLM. Described are example techniques for providing input to an LLM in which examples are structured to resemble client/LLM message pairs and inserted in an ongoing conversation history, instead of examples being provided in the system-generated portion of the input as is conventionally done. This enables the LLM to generate output that better matches the example LLM message in the example client/LLM message pairs. After the LLM has generated the output, the inserted examples can be removed from the conversation history to save resources.

While an LLM is discussed in examples of the present disclosure, it should be understood that other types of generative models, including image generation models, and other machine learning models that accepts unstructured inputs (e.g., natural language inputs) may benefit from aspects of the present disclosure. As such, the present disclosure is not necessarily limited to implementation with an LLM.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

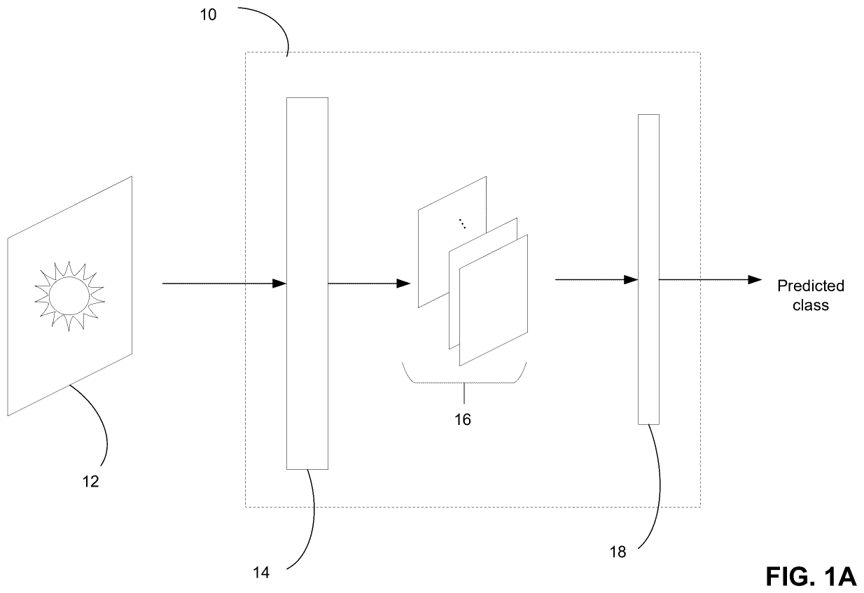

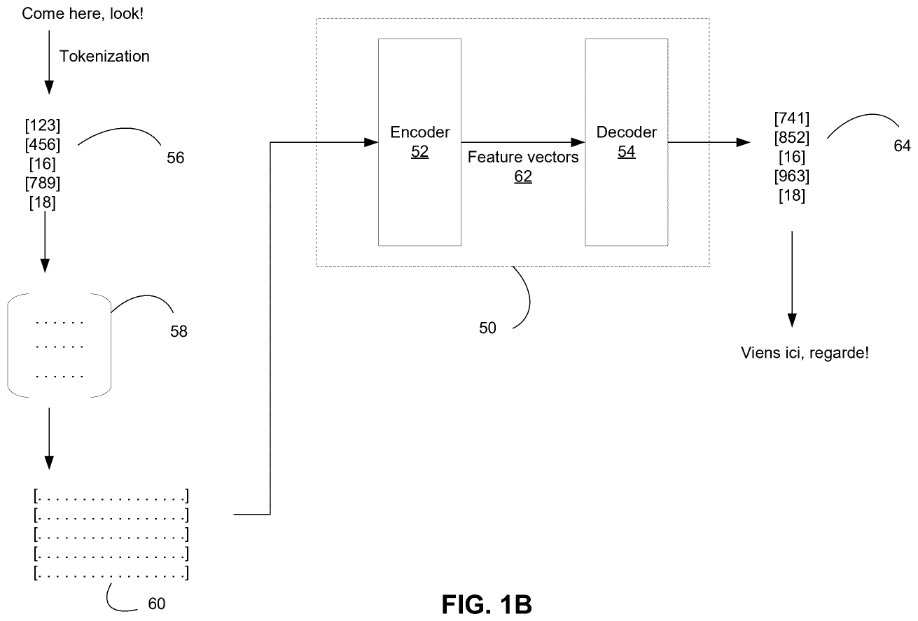

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

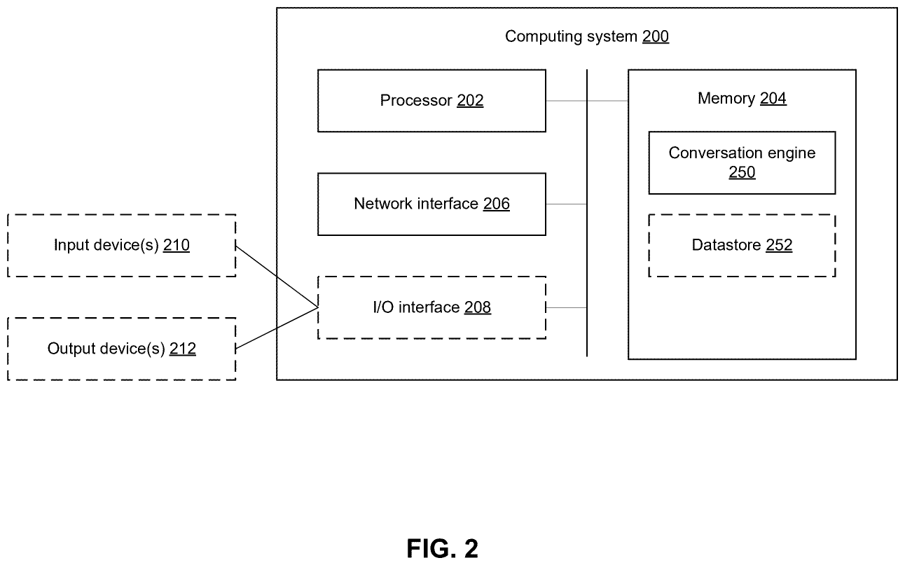

FIG. 2 illustrates an example computing system 200, which may be used to implement examples of the present disclosure. For example, the computing system 200 may be used to generate a prompt to an LLM to cause the LLM to generate output. Additionally or alternatively, one or more instances of the example computing system 200 may be employed to execute the LLM. For example, a plurality of instances of the example computing system 200 may cooperate to provide output using an LLM in manners as discussed above.

The example computing system 200 includes at least one processing unit and at least one physical memory 204. The processing unit may be a hardware processor 202 (simply referred to as processor 202). The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to cause the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). The network interface 206 may enable the computing system 200 to carry out communications (e.g., wireless communications) with systems external to the computing system 200, such as a LLM residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

As noted above, the input to an LLM may be referred to as a prompt, and providing the input to the LLM may be referred to as prompting the LLM. In the present disclosure, the input to the LLM may be in the context of an ongoing conversation between a client and the LLM. The input to the LLM may include a system message (also referred to as a developer message) as well as a client message. The system message (sometimes referred to as a system prompt) instructs the LLM how to act (e.g., provides the LLM with a role) to reply to the client message. The client message is typically a conversational input from a user, which may be in the form of a question or request. In response to the input, the LLM generates an output that may be used to provide an LLM message (sometimes referred to as an assistant message, such as in cases where the LLM is assigned the role of an assistant) in the conversation. The LLM message may be in the form of an answer or response to the client's question or request.

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing a conversation engine 250. The memory 204 may also store data, such as a datastore 252 that stores example message pairs, as discussed further below. In some examples, the datastore 252 may be stored remotely in a separate computing system from the conversation engine 250.

In some examples, the computing system 200 may be a server of an online platform that provides the conversation engine 250 as a web-based or cloud-based service that may be accessible by a user device (e.g., via communications over a wireless network). Other such variations may be possible without departing from the subject matter of the present application.

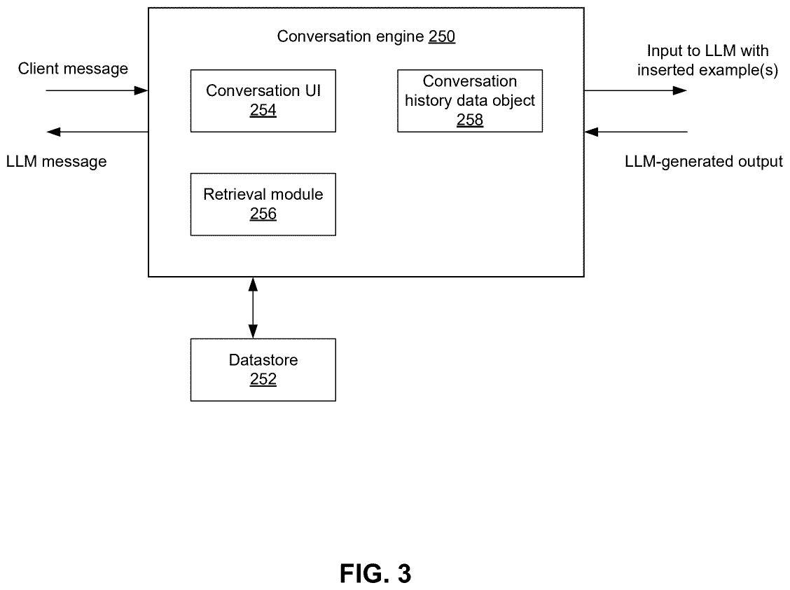

FIG. 3 is a block diagram illustrating details of an example conversation engine 250. The operations of the conversation engine 250 will be described for processing a current client message, providing an input an LLM with one or more inserted example(s), and providing an LLM message based on the LLM-generated output, in the context of an ongoing conversation between a client and an LLM (which may be represented as a chat bot, intelligent assistant, virtual assistant, etc.).

In the present disclosure, an ongoing conversation may refer to a currently active conversation session between a client and an LLM (e.g., via the conversation engine 250). In the example shown, the conversation engine 250 includes a conversation UI 254 and a retrieval module 256. The conversation engine 250 may store a conversation history data object 258; alternatively, the conversation history data object 258 may be stored external to the conversation engine 250 (e.g., in the memory of 204 of the computing system 200 or in a remote system). The example shown is not intended to be limiting. It should be understood that there may be greater or fewer modules in the conversation engine 250. Operations described as being performed by a particular module may be performed by a different module, or may be an overall function of the conversation engine 250, for example.

The conversation engine 250 may communicate with an LLM (not shown) that may be hosted by a remote system external to the computing system 200. For example, the conversation engine 250 may generate and send inputs to the LLM via API calls, and may receive outputs generated by the LLM in response.

The conversation UI 254 may provide an interface for a client (e.g., in the case where a human user is using a client device) to provide client messages and view LLM messages in the ongoing conversation. For example, the conversation UI 254 may provide an interface in the form of a virtual assistant for an application, a website or portal, among other applications. In some examples, the conversation UI 254 may be configured to render user interface elements in the conversation. For example, the LLM may be pre-trained to generate output that includes code that the conversation UI 254 may use to render user interface elements in the conversation. In some examples, the ongoing conversation may be carried out without the use of the conversation UI 254 (e.g., in the case where the conversation is between a client and the LLM without involvement of a human user).

Messages in the conversation, including both client messages as well as LLM messages based on output generated by the LLM, are maintained in the conversation history data object 258 at least for the duration of the conversation session. The conversation history data object 256 may be a dynamic data object 256 that grows as messages are added to the ongoing conversation. As the conversation is an ongoing conversation, the conversation history data object 258 may increase in size (e.g., increase in the amount of memory required to store the conversation history, increase in the number of words or characters stored and/or increase in the number of messages stored) as messages are added to the conversation. When the conversation ends (e.g., by the client terminating the session, by a timeout, etc.), the conversation history data object 258 may or may not be stored for future use. In some examples, the conversation engine 250 may implement various mechanics to ensure the conversation history data object 256 does not exceed a maximum size (e.g., maximum number of tokens, maximum number of words, maximum number of messages, etc.). In an example, a sliding window (in which the size of the sliding window may be defined by a number of tokens) may be used, such that the conversation history data object 256 only contains the most recent messages that fit within the size of the sliding window. The size of the sliding window may be defined based on a context window limit of the LLM, for example. If the conversation history data object 256 exceeds the size of the window, the oldest message may be removed from the conversation history data object 256. Older messages may be removed from the conversation history data object 256 in whole (i.e., an entire message is removed, not just a portion of the message) to avoid leaving message fragments in the conversation history data object 256 that may be misinterpreted by the LLM. Other techniques for maintaining the size of the conversation history data object 256 may be used.

When the conversation engine 250 receives a client message (e.g., via the conversation UI 254), the conversation engine 250 generates an input to the LLM to cause the LLM to generate an output that can be used to provide an LLM message in the conversation. The input to the LLM may have the following general format:
System message
Client message 1
LLM message 1
Client message 2
LLM message 2
Current client message

The system message sets forth the general behavior of the LLM (e.g., to act as an assistant to the client). The input includes historical messages in the conversation, indicated above as client message 1, LLM message 1, client message 2 and LLM message 2. The historical messages may be some or all of the historical messages maintained in the conversation history data object 258. By including at least a portion of the conversation history in the input, the LLM is provided with contextual information so that the LLM is able to generate output more suitable to the current context. The current client message is the message for which the LLM is to generate an output in reply.

The conversation engine 250 may format the input to the LLM (e.g., formatted into an API request), for example formatted into a particular type of data structure (e.g., JSON data structure). The input is then provided to the LLM (e.g., via an API to a remote LLM, or to a local LLM). The input is tokenized (e.g., by a tokenizer specific to the LLM), processed by the LLM and the output generated by the LLM is then received by the conversation engine 250. The conversation engine 250 may process the LLM-generated output (e.g., parse the output to check for syntax, in cases where the LLM-generated output includes code) and use to provide an LLM message in the conversation. If the LLM-generated output includes code to be rendered in the conversation UI 254 (e.g., code for rendering user interface elements), the conversation UI 254 may render the code to be displayed at the client.

The process described above may be performed by the conversation engine 250 each time a new client message is received. Each client message and LLM message in the conversation may be added to the conversation history data object 258 (which grows as the conversation is ongoing).

In some cases, the retrieval module 256 may retrieve one or more examples from the datastore 252 (which may be stored locally or may be accessed remoted) and insert the retrieved example(s) into the input to the LLM. In particular, each example inserted into the input to the LLM may resemble client/LLM message pairs (i.e., each example has a client message and a corresponding LLM message, thus each example is a pair of messages) in a conversation (e.g., question and answer message pairs, request and response message pairs, etc.). In some examples, a retrieved example may have more than one pair of messages. For example, a retrieved example may have multiple client/LLM message pairs, such as where an example illustrates a more complex task that may require multiple steps. Although the present disclosure refers to an example being a message pair, it should be understood that this also encompasses examples where there are multiple client/LLM message pairs in one example.

The retrieved example(s) are dynamically inserted into the input to the LLM in a manner such that the inserted example(s) appear to be part of the conversation history included in the input. In particular, the example(s) may be inserted in the conversation history in proximity to the current client message (e.g., in a location in the conversation history that represents closest temporal proximity to the current client message, such as immediately preceding the current client message).

The conversation engine 250 may thus generate input to the LLM according to the following example format:
System message
Client message 1
LLM message 1
Client message 2
LLM message 2
<Example> Client message 1
<Example> LLM message 1
Current client message

The example format show above includes an example message pair (e.g., indicated by special <Example> labels) inserted into the conversation history portion of the input, at a location in proximity (e.g., immediately next to or immediately preceding) the current client message. In this example, special <Example> labels are used to indicate the inserted example message pair, to enable later removal of the inserted message, as described below. However, this is only by way of illustration and is not intended to be limiting, other techniques for indicating the inserted example message pair (e.g., by storing a location where the example message pair was inserted in the conversation history, such as by storing offsets and run lengths or spans, etc.) may be used.

Depending on how the LLM was developed and trained, the LLM may have an inherent tendency to apply greater attention to more recent messages (sometimes referred to as a recency bias). This means that, if a long conversation history is included in the input to the LLM, examples provided in a system message preceding the conversation history can end up being ignored by the LLM when the LLM generates the output. By inserting example(s) into the conversation history portion of the input to the LLP, in a form that resembles client/LLM message pairs, and at a location that is close to the current client message (which may correspond to being more recent in the conversation history), the conversation engine 250 may cause the LLM to place greater attention on the inserted example(s). This may cause the LLM to generate output that is more informed by the inserted example(s) compared to other approaches that insert examples in the system message portion of the input. It should also be noted that providing examples in the current client message itself would be less desirable, as this may obfuscate the actual current client message and cause the LLM to place more attention on the example messages than the current client message, resulting in output that does not adequately answer the current client message. As well, providing examples in the form of client/LLM message pairs, rather than example LLM messages alone (without example client messages), better matches the typical conversation that the LLM has been trained on, enabling the LLM to generate better quality output.

It should be noted that although the conversation engine 250 may insert example(s), retrieved by the retrieval module 256 from the datastore 252, into the conversation history portion of the input to the LLM, the inserted example(s) may not be part of the conversation history stored in the conversation history data object 258. That is, the inserted example(s) may be only temporarily added to the conversation history. After the input with inserted example(s) has been processed by the LLM to generate an output, the inserted example(s) may then be removed from the conversation history, leaving only the actual client/LLM messages between the client and LLM stored in the conversation history data object 258. In this way, fewer computing resources, including token resources, may be consumed due to the reduced size of the conversation history data object 258 that has to be processed by the LLM in generating a response to any subsequent client messages as compared to, for example, a system in which the inserted example(s) are included in the conversation history stored in the conversation history data object 258. It should be noted that reducing the size of the conversation history data object 258 in this way may negatively impact prompt caching, which is a technique that enables an LLM to more efficiently generate output for an input that is similar to a previously-processed input (or prompt). Thus, there may be a trade-off between reducing the size of the conversation history and enabling prompt caching.

It should also be noted that any example(s) inserted into the input to the LLM in the manner disclosed herein are not outputted to the client (e.g., not provided as a message to be displayed in the conversation UI 254), so that the client does not know that any example(s) were inserted into the conversation history (and subsequently removed). Notably, the insertion of the example(s) into the conversation history portion of the input to the LLM may be a function of the conversation engine 250 rather than a function of the conversation UI 254, such that a history of messages displayed in the conversation UI 254 is not affected by changes made to the conversation history in the process of providing input to the LLM and receiving output from the LLM. If the conversation UI 254 requests access to the conversation history (e.g., if a user wishes to view a history of all messages in the ongoing conversation), the conversation UI 254 may retrieve the conversation history from the conversation history data object 258, which may be free of any inserted examples. In other words, modification of the conversation history in the manner disclosed may be entirely hidden from the client.

Thus, the LLM is provided with examples that enable the LLM to mimic the conversational messages, in accordance with the content of the example LLM message in the client/LLM example message pairs. The result is that the output generated by the LLM is able to draw on information from retrieved data while at the same time being suitable for the context of an ongoing conversation.

As described previously, example client/LLM message pairs (which may also be referred to as question and answer message pairs, or request and response message pairs, or simple message pairs, among other possibilities) may be retrieved from the datastore 252 by the retrieval module 256. The example message pairs (also simply referred to as examples) stored in the datastore 252 may be extracted from real-life conversations between a client and the LLM where the LLM message was considered a suitable or satisfactory (e.g., based on sentiment analysis, human judge, etc.) response to a client message. Example client/LLM message pairs may also be created by human experts. Various techniques may be used to create example client/LLM message pairs to populate a datastore, including synthetic data generation techniques that do not involve human intervention.

The retrieval module 256 may use the current client message, received by the conversation engine 250, as a query to search the datastore 252 for one or more relevant examples that can then be inserted into the input to the LLM as described above. A relevant example is one that is relevant to the semantic meaning of the current client message and/or relevant to a task requested by the current client message. In some examples, the retrieval module 256 may cause the current client message to be encoded into a query embedding. The retrieval module 256 may include an embedding encoder that encodes the current client message into the query embedding, or the retrieval module 256 may provide the current client message to an embedding encoder that is hosted by the computing system 200 (e.g., may be part of the conversation engine 250 or another module stored in the memory 204) or that is remotely located. The datastore 252 may store each example with a corresponding embedding (that is, an embedding generated from the corresponding example). The retrieval module 256 may then retrieve one or more example client/LLM message pairs from the datastore 252 based on similarity (e.g., vector-based similarity, such as cosine similarity) of their embeddings to the query embedding. Various techniques that provide for retrieval of relevant data, such as techniques used in RAG systems, may be used.

The number of retrieved examples may be limited to a maximum number (e.g., no more than three example client/LLM message pairs), to limit the amount of resources (e.g., tokens, memory, etc.) consumed by the examples inserted into the conversation history portion of the input to the LLM. For example, the conversation engine 250 may define a limited amount of resources (e.g., maximum number of tokens, maximum text length, maximum memory size, etc.) to use for the conversation history portion of the input to the LLM. In some examples, there may be a minimum similarity threshold (e.g., at least 80% vector similarity to the query embedding) that must be met for an example to be retrieved from the datastore 252. If no example is found that meets the minimum similarity threshold, then the input to the LLM may not include any inserted examples.

Optionally, if two or more example client/LLM message pairs are retrieved from the datastore 252, the order in which the example message pairs is inserted into the conversation history portion of the input to the LLM may be based on the similarity with the current client message. In particular, an example with greater similarity to the current client message (e.g., based on vector similarity determined by the retrieval module 256) may be placed more proximal to the current client message (e.g., immediately preceding the current client message), while another example with lesser similarity may be placed less proximal to the current client message.

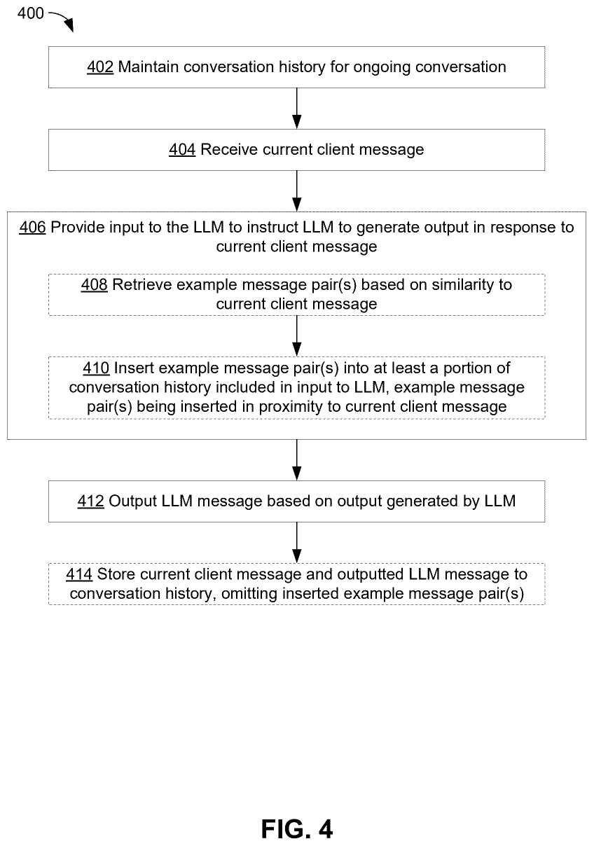

FIG. 4 is a flowchart of an example method 400 for an example embodiment of the present disclosure, which may be performed by a computing system, in accordance with examples of the present disclosure. For example, a processing unit of a computing system (e.g., the processor 202 of the computing system 200 of FIG. 2) may execute instructions (e.g., instructions of the conversation engine 250) to cause the computing system to carry out the example method 400. The method 400 may, for example, be implemented by an online platform or a server. The method 400 may be used to provide input to an LLM that includes one or more example message pairs as disclosed herein. The LLM may be a generative pre-trained transformer LLM, such as LLaMA, Falcon 40B, GPT-3, GPT-4 or ChatGPT, among others. Further, it should be understood that the LLM may be a multi-modal LLM (e.g., BLIP-2, CLIP, GPT-4V, etc.) that is capable of processing multi-modal inputs (e.g., inputs that include text, images, other media, and combinations thereof). Although an LLM is described in some examples, the present disclosure may be applicable to any generative model, including any generative text model or any generative multi-modal or multimedia model. Thus, it should be understood that the present disclosure is not intended to be limited to LLMs and is not intended to be limited to text-only messages. The operations of the conversation engine 250 as described above may illustrate an example implementation of the method 400.

The method 400 may be performed during an ongoing conversation conducted between a client (e.g., a user may be providing messages via a client device) and an LLM. For example, a UI (e.g., the conversation UI 254 provided by the conversation engine 250) may enable a user to provide input via a client device, and the UI may be used to present messages (e.g., client messages and LLM messages) on the client device. Each message in the conversation may contain text, image(s), audio, UI element(s), etc. Thus, the conversation need not be a text-only conversation.

At an operation 402, the system maintains a conversation history for an ongoing conversation. For example, the conversation history may be maintained in a memory of the system by the conversation engine 250 as the conversation history data object 258, which grows as new messages are added to the ongoing conversation. The conversation history contains one or more previous messages from the client (also referred to simply as client messages) and one or more messages from the LLM (also referred to simply as LLM messages) in the conversation.

At an operation 404, a current client message for the ongoing conversation is received from the client (e.g., via the conversation UI 254 provided by the conversation engine 250).

At an operation 406, the system provides input to the LLM (also referred to as prompting the LLM) to instruct the LLM to generate an output in response to the current client message. As disclosed herein, the input to the LLM includes at least a portion of the conversation history. One or more example message pairs are inserted into at least the portion of the conversation history included in the input to the LLM. The one or more example message pairs are inserted into the input to the LLM in proximity to (e.g., immediately preceding) the current client message. Notably, the proximity of the example message pair(s) to the current client message may represent, to the LLM, a temporal proximity between the example message pair(s) and the current client message (e.g., the LLM may process the example message pair(s) as though they were messages in the conversation immediately before the current client message). Each example message pair includes a respective example client message and a respective example LLM message. The example client message should be semantically similar to the current client message, and the corresponding example LLM message should represent a suitable response to the example client message. Thus, the example message pair(s) provide information demonstrating to the LLM what output is considered to be a suitable response to the current client message (which is semantically similar to the example client message in each example message pair(s)).

The operation 406 may be carried out using the operation 408 and the operation 410.

At the operation 408, the system may (e.g., using the retrieval module 256) retrieve example message pair(s) from a datastore (e.g., the datastore 252) based on similarity to the current client message. In some examples, a measure of similarity (e.g., based on similarity of corresponding embeddings, for example using Euclidean distance between embeddings in the embedding space as a measure of similarity) between the current client message and example message pair(s) in the datastore may be used to identify and retrieve one or more message pairs. For example, the current client message may be encoded into a query embedding that is used to query the datastore. Each example message pair in the datastore may have a corresponding example embedding. Then similarity between the query embedding and example embedding(s) may be used to identify and retrieve the one or more example message pair(s). In particular, the similarity to the current client message should be determined based on similarity between the current client message and the example client message in each example message pair (i.e., similarity between the current client message and the example LLM message in each example message pair may not need to be considered).

In some examples, a minimum similarity threshold may be applied by the system, such that the similarity (e.g., based on embedding similarity) between the current client message and an example message pair must meet the minimum similarity threshold (e.g., at least 80% similarity) in order for that example message pair to be considered similar enough to be retrieved. In some examples, a maximum number (e.g., five or fewer, or three or fewer) of example message pairs may be retrieved from the datastore, to avoid excessively increasing the size (e.g., token size) of the input to the LLM by insertion of a large number of example message pairs.

At an operation 410, the retrieved example message pair(s) are inserted into the input to the LLM. In particular, the example message pair(s) are inserted into at least a portion of conversation history that is included in the input to the LLM. The example message pair(s) are inserted into the input to the LLM in proximity to the current client message. Insertion of the example message pair(s) into the portion of conversation history in this manner may involve temporarily inserting the example message pair(s) into the conversation history for the purpose of inclusion into the input to the LLM, however it should be noted that the inserted example message pair(s) are subsequently removed (after output is received from the LLM in response to the input) from the conversation history, such that the example message pair(s) are omitted from the conversation history maintained by the system.

If two or more example message pairs have been retrieved (e.g., at the operation 408), then the example message pairs may be inserted into the portion of the conversation history in the input to the LLM based on their respective similarity to the current client message. For example, consider a first example message pair having a first example client message and a first example LLM message, and a second example message pair having a second example client message and a second example LLM message. If the similarity between the first example client message and the current client message is greater than the similarity between the second example client message and the current client message, then the first example message pair (including both the first example client message and the first example LLM message) may be inserted into the portion of the conversation history in the input to the LLM in greater proximity to the current client message, compared to the location where the second example message pair is inserted.

The input to the LLM is provided to the LLM (e.g., via an API request, in the case where the LLM is hosted remotely from the system). The LLM generates output in response to the input.

At an operation 412, an LLM message is outputted to the conversation (e.g., outputted via the conversation UI 254 provided by the conversation engine 250), based on the output generated by the LLM. In some examples, the output from the LLM may be processed (e.g., parsed by the conversation engine 250) in order to generate the LLM message that is outputted to the conversation.

At an operation 414, the current client message and the LLM message may be stored in the conversation history maintained by the system (e.g., stored in the conversation history data object 258). However, the conversation history that is maintained by the system is free of the example message pair(s) that were inserted into the conversation history as part of the input to the LLM. As previously discussed, any example message pairs inserted into the conversation history may be identified (e.g., using a special label or tag, using an indication of where the example message pair was inserted, etc.) and removed from the conversation history after the input to the LLM has been provided to the LLM. In this way, insertion of any example message pairs into the conversation history may be entirely hidden from the client (e.g., inserted example message pairs may not be displayed by the conversation UI 254).

The method 400 may be performed repeatedly over the course of a conversation between the client and the LLM. That is, the operations 402-414 may be iterated for each new client message received in the conversation. For example, a further client message may be received (at the operation 404). The system may then provide a further input to the LLM to instruct the LLM to generate a further output in response to the further client message (at the operation 406). This may involve retrieving new example message pair(s) based on similarity to the further client message (at the operation 408) and inserting the retrieved new example message pair(s) into at least a portion of the conversation history included in the input to the LLM, in proximity to the further client message (at the operation 410). Notably, the conversation history included in the further input to the LLM is free of any previously inserted example message pairs. That is, any example message pairs inserted in a previous iteration of the method 400 are omitted from the conversation history maintained by the system and therefore do not form part of the conversation history in a subsequent iteration of the method 400. A further LLM message may then be outputted based on further output generated by the LLM in response to the further input (at the operation 412). The further client message and further LLM message may be added to the conversation history maintained by the system (at the operation 414), however the new example message pair(s) are omitted from the conversation history.

Thus, the system generates an input to the LLM that causes the LLM to generate output in response to a current client message, where the output is informed by example message pairs that demonstrate to the LLM a suitable response to the current client message. The example message pairs may be similar to client/LLM messages in the ongoing conversation, enabling the LLM to generate more appropriate conversational output, while being informed by the provided example message pairs. Additionally, the example message pairs are inserted into the input to the LLM at a position that corresponds to a temporal proximity to the current client message, which enables the LLM to put more attention on the example message pairs compared to if the example message pairs were part of the system message (which is typically at the start of the input to the LLM and far from the current client message). This approach may be more effective at causing the LLM to generate output that is informed by the example message pairs, compared to conventional N-prompting techniques. The inserted example message pairs may be omitted from the conversation history, to avoid increasing the size of the conversation history, however there may be a trade-off with possibly less effective prompt-caching as discussed previously.

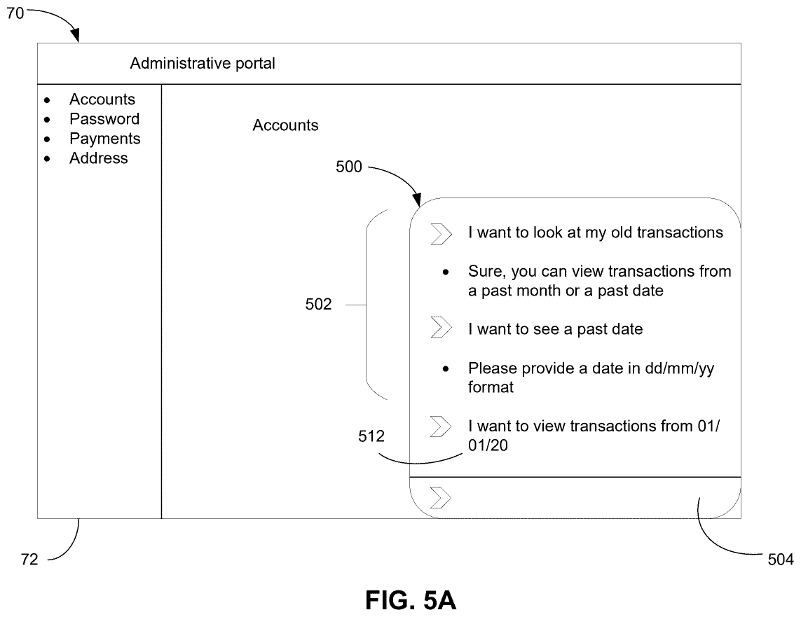

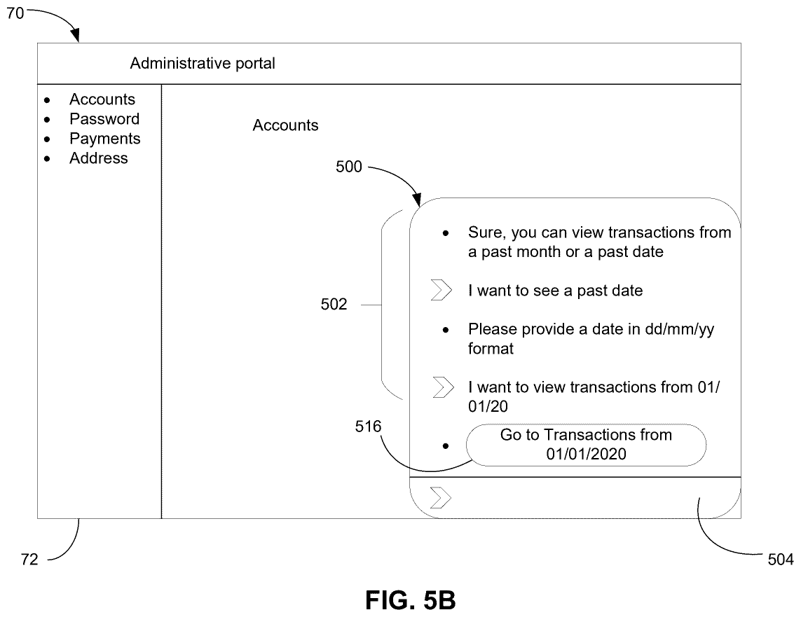

FIGS. 5A-5C illustrate an example of a simplified conversation UI, which may be implemented by an example of the conversation engine 250 as disclosed herein (e.g., using the example method 400). In this example, the ongoing conversation is conducted in the context of a virtual assistant for a web portal being navigated by a user via a client device. In this simple example, the user is viewing and navigating through an administrative portal 70 that has multiple pages or tabs, as indicated in the navigation bar 72. It should be understood that this example is not intended to be limiting.

An interface 500 for an ongoing conversation (e.g., provided by the disclosed conversation engine 250) is presented to the user via the client device. The interface 500 includes a partial conversation history 502 displaying the most recent messages in the conversation (including both client messages indicated by a chevron and LLM messages (also referred to as assistant messages) indicated by a dot) and an input portion 504 in which the user may enter input, such as text input, image input, etc. In some examples, the user may provide input by other means, such as voice input and/or touch input.

In FIG. 5A, there are previous client messages and LLM messages in the partial conversation history 502 shown in the interface 500. It should be understood that there may be more messages in the stored conversation history that is not shown in the interface 500 (e.g., due to space constraints). In this example, the user has provided a current client message 512 requesting to view previous transactions on the date Jan. 1, 2020. This may be processed by the LLM as a request to generate a navigation link (e.g., to generate an URL to navigate to a webpage containing the requested transactions). However, the LLM may not be familiar with the specific URL that is appropriate to the present administrative portal 70. For example, the LLM may have been trained to generate navigation URLs using various common conventions. Without further information about the URL format used by the administrative portal 70, the LLM may, for example, generate output with the URL https://website.com/transactions?date=01012020 or https://website.com/admin?page=transactions; date=01012020 or https://website.com/admin/transactions/01012020. These three conventions (among other possibilities) may be present in the wide ranging LLM training data and may all be valid in different contexts, but only one is useful for providing a successful navigation command in the current administrative portal 70.

The conversation engine 250 may insert example message pair(s) into the input to the LLM, as disclosed herein, to provide the LLM with examples of the correct URL format inserted into the conversation history. An example of an input to the LLM that may be generated by the conversation engine 250 is as follows:
You are a help centre assistant here to answer a user's questions and help them navigate the portal. You should provide answers based on your earlier conversation with the user.

Here is the recent relevant conversation:
User: I want to look at my old transactions
Assistant: Sure, you can view transactions from a past month or a past date
User: I want to see a past date
Assistant: Please provide a date in dd/mm/yy format
<Example> User: Please navigate to date Mar. 4, 2023
<Example> Assistant: Navigate: https://website.com/transactions/date/030423
<Example> User: Can you go to transactions on date Dec./12/12?
<Example> Assistant: Navigate: https://website.com/transactions/date/121212
User: I want to view transactions from Jan./01/20

The input to the LLM includes a system message instructing the LLM on its role, followed by at least a portion of the conversation history leading up to the current client message. In the example above, two example message pairs have been inserted into the conversation history immediately preceding the current client message. In this example, the inserted example message pairs are labeled with <Example> labels, however this is only illustrative and not intended to be limiting. In response to this example input, the LLM may then generate an output “Navigate: https://website.com/transactions/date/010120”, based on the information provided in the example client/LLM message pairs.

FIG. 5B illustrates the interface 500 updated with a new LLM message based on the LLM-generated output. In particular, in response to the client message “I want to view transactions from Jan./01/20”, the LLM message includes a navigation link (which may be rendered by the conversation UI 254 as a user interface element 516, such as a selectable button) with the correct navigation URL https://website.com/transactions/date/010120.

Notably, the example message pairs are not shown in the partial conversation history 502 displayed in the interface 500. Further, after the LLM has generated the output, the inserted example message pairs may be removed and omitted from the conversation history that is maintained for the ongoing conversation. That is, the conversation history may have only the following messages:
User: I want to look at my old transactions
Assistant: Sure, you can view transactions from a past month or a past date
User: I want to see a past date
Assistant: Please provide a date in dd/mm/yy format
User: I want to view transactions from Jan. 1, 2020
Assistant: Navigate: https://website.com/transactions/date/010120

In this example, the LLM is enabled to respond with a more correct response (e.g., the correct URL) than it would have without the examples inserted into the conversation history immediately preceding the current client message. It should also be appreciated that because there are several messages in the conversation history separating the system message from the current client message, inserting examples into the conversation history in this manner causes the LLM to place greater attention on the examples compared to if the examples were inserted into the system message (as in conventional N-shot prompting), due to the LLM's inherent recency bias.

In various examples, the present disclosure provides a technical solution that enables examples to be included in an input to an LLM in which the inserted examples mimic client/LLM messages in a conversation and are provided closer to (but not part of) the current client message, to enable the LLM to generate output with greater attention placed on the inserted examples.

The inserted examples are omitted from the conversation history after the LLM has generated an output so that the size of the conversation history is not increased by the inserted examples, saving resources (e.g., tokens, network bandwidth, memory, etc.) in subsequent input, that includes the conversation history, to the LLM. The disclosed examples therefore provide an efficient and effective technique for instructing an LLM to generate output based on included examples.

Although the present disclosure includes examples of transformer-based language models, it should be understood that the present disclosure may be applicable to any machine learning-based language model, including language models based on other neural network architectures such as recurrent neural network (RNN)-based language models. Examples involving the use of an LLM is merely by way of example and the present disclosure is not necessarily so limited. For example, the techniques disclosed herein could potentially also be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM in it, may be employed in association with the above-discussed techniques.

Although the present disclosure has described a LLM in various examples, it should be understood that the LLM may be any suitable language model (e.g., including LLMs such as LLaMA, Falcon 40B, GPT-3, GPT-4 or ChatGPT, as well as other language models such as BART, among others).

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
maintaining a conversation history for an ongoing conversation between a client and a large language model (LLM), the conversation history containing one or more previous messages from the client and one or more previous messages from the LLM;
receiving, from the client, a current client message for the ongoing conversation;
providing an input to the LLM to instruct the LLM to generate an output in response to the current client message, the input to the LLM including at least a portion of the conversation history and including one or more example message pairs inserted into the at least the portion of the conversation history in proximity to the current client message, wherein each example message pair includes a respective example client message and a respective example LLM message; and
outputting, to the client, an LLM message based on the output generated by the LLM in response to the input;
wherein the one or more example message pairs are omitted from the maintained conversation history.

2. The method of claim 1, wherein, for each example message pair, the respective example client message is semantically similar to the current client message and the corresponding respective example LLM message is a suitable response to the example client message.

3. The method of claim 2, wherein two or more example message pairs are inserted into the at least the portion of the conversation history, wherein a first message pair having a first example client message that is more similar to the current client message is inserted into the at least the portion of the conversation history in greater proximity to the current client message than a second message pair having a second example client message that is less similar to the current client message.

4. The method of claim 1, further comprising:
retrieving, from a datastore, the one or more example message pairs based on similarity to the current client message.

5. The method of claim 4, further comprising:
encoding the current client message into a query embedding to query the datastore; and
retrieving the one or more example message pairs based on similarity between the query embedding and one or more example embeddings corresponding to the one or more example message pairs.

6. The method of claim 1, wherein the insertion of the one or more example message pairs into the at least the portion of the conversation history is hidden from the client.

7. The method of claim 1, further comprising:
adding the current client message and the outputted LLM message to the maintained conversation history; and
maintaining the conversation history free of the inserted one or more example message pairs.

8. The method of claim 1, further comprising:
receiving, from the client, a further client message for the ongoing conversation;
providing a further input to the LLM to instruct the LLM to generate a further output in response to the further client message, the further input including at least a portion of the conversation history free of any previously inserted example message pairs, and including one or more new example message pairs inserted into the at least the portion of the conversation history in proximity to the further client message; and
outputting, to the client, a further LLM message based on the further output generated by the LLM in response to the further input;
wherein the one or more new example message pairs are omitted from the maintained conversation history.

9. A computer system comprising:
at least one processor; and
a computer readable medium storing instructions that, when executed by the at least one processor, cause the computer system to:
maintain a conversation history for an ongoing conversation between a client and a large language model (LLM), the conversation history containing one or more previous messages from the client and one or more previous messages from the LLM;
receive, from the client, a current client message for the ongoing conversation;
provide an input to the LLM to instruct the LLM to generate an output in response to the current client message, the input to the LLM including at least a portion of the conversation history and including one or more example message pairs inserted into the at least the portion of the conversation history in proximity to the current client message, wherein each example message pair includes a respective example client message and a respective example LLM message; and
output, to the client, an LLM message based on the output generated by the LLM in response to the input;
wherein the one or more example message pairs are omitted from the maintained conversation history.

10. The computer system of claim 9, wherein, for each example message pair, the respective example client message is semantically similar to the current client message and the corresponding respective example LLM message is a suitable response to the example client message.

11. The computer system of claim 10, wherein two or more example message pairs are inserted into the at least the portion of the conversation history, wherein a first message pair having a first example client message that is more similar to the current client message is inserted into the at least the portion of the conversation history in greater proximity to the current client message than a second message pair having a second example client message that is less similar to the current client message.

12. The computer system of claim 9, wherein the instructions further cause the computer system to:
retrieve, from a datastore, the one or more example message pairs based on similarity to the current client message.

13. The computer system of claim 12, wherein the instructions further cause the computer system to:
encode the current client message into a query embedding to query the datastore; and
retrieve the one or more example message pairs based on similarity between the query embedding and one or more example embeddings corresponding to the one or more example message pairs.

14. The computer system of claim 9, wherein the insertion of the one or more example message pairs into the at least the portion of the conversation history is hidden from the client.

15. The computer system of claim 9, wherein the instructions further cause the computer system to:
add the current client message and the outputted LLM message to the maintained conversation history; and
maintain the conversation history free of the inserted one or more example message pairs.

16. The computer system of claim 9, wherein the instructions further cause the computer system to:
receive, from the client, a further client message for the ongoing conversation;
provide a further input to the LLM to instruct the LLM to generate a further output in response to the further client message, the further input including at least a portion of the conversation history free of any previously inserted example message pairs, and including one or more new example message pairs inserted into the at least the portion of the conversation history in proximity to the further client message; and
output, to the client, a further LLM message based on the further output generated by the LLM in response to the further input;
wherein the one or more new example message pairs are omitted from the maintained conversation history.

17. A non-transitory computer-readable medium storing instructions that, when executed by at least one processor of a computer system, cause the computer system to:
maintain a conversation history for an ongoing conversation between a client and a large language model (LLM), the conversation history containing one or more previous messages from the client and one or more previous messages from the LLM;
receive, from the client, a current client message for the ongoing conversation;
provide an input to the LLM to instruct the LLM to generate an output in response to the current client message, the input to the LLM including at least a portion of the conversation history and including one or more example message pairs inserted into the at least the portion of the conversation history in proximity to the current client message, wherein each example message pair includes a respective example client message and a respective example LLM message; and
output, to the client, an LLM message based on the output generated by the LLM in response to the input;
wherein the one or more example message pairs are omitted from the maintained conversation history.

18. The non-transitory computer-readable medium of claim 17, wherein, for each example message pair, the respective example client message is semantically similar to the current client message and the corresponding respective example LLM message is a suitable response to the example client message.

19. The non-transitory computer-readable medium of claim 18, wherein two or more example message pairs are inserted into the at least the portion of the conversation history, wherein a first message pair having a first example client message that is more similar to the current client message is inserted into the at least the portion of the conversation history in greater proximity to the current client message than a second message pair having a second example client message that is less similar to the current client message.

20. The non-transitory computer-readable medium of claim 17, wherein the instructions further cause the computer system to:
add the current client message and the outputted LLM message to the maintained conversation history; and
maintain the conversation history free of the inserted one or more example message pairs.
